(19) United States
(12) Patent Application Publication
(10) Pub. No.: US 2009/0168131 A1
(43) Pub. Date: Jul. 2, 2009

(54) IMAGE DISPLAY APPARATUS AND HEAD-MOUNTED DISPLAY

(75) Inventors: Hiroshi Yamaguchi, Osaka-shi (JP); Yasushi Tanijiri, Osakasayama-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/233,899

(22) Filed: Sep. 19, 2008

(30) Foreign Application Priority Data
Dec. 28, 2007 (JP) 2007-338438
Dec. 28, 2007 (JP) 2007-338453

(51) Int. Cl. G02B 5/32

(52) U.S. Cl. 359/13; 359/15; 359/9

(57) ABSTRACT

Provided is an image display apparatus that has resistance to dust and water, that is compact and lightweight, and that has see-through characteristics. The image display apparatus is provided with a display device displaying an image, a prism guiding light of the image displayed by the display device to an optical pupil, and transmitting outside light such that an outside world can be viewed therethrough, and an enclosure housing and holding the display device and part of the prism. Here, a first sealing member is provided so as to make contact with a part around the prism where image light is not reflected and with the enclosure.

This application is based on Japanese Patent Applications Nos. 2007-338438 and 2007-338453 both filed on Dec. 28, 2007, the contents of which are hereby incorporated by reference.

### BACKGROUND OF THE INVENTION

1. Field of the Invention

The present invention relates to image display apparatuses that present a viewer with an image displayed by a display device as a virtual image, and head-mounted displays (hereinafter also referred to as “HMDs”) provided with such image display apparatuses.

2. Description of Related Art

To date, various so-called HMDs, head-mounted image display apparatuses, have been proposed. Recently, HMDs are beginning to be used not just in general consumer goods, but for the purpose of assisting the user in carrying out operations smoothly by providing various information for the user. Depending on the environment in which the HMDs will be used, they are required to have a function that is not needed when used as general consumer goods. For example, in a case where the HMDs are used outdoors, they are expected to have resistance to dust and water. In response to this, several techniques for realizing HMDs having resistance to dust and water have been proposed.

For example, an HMD disclosed in JP-A-H11-296095 incorporates an LCD that is a device for displaying a two-dimensional image, and a backlight for illuminating the LCD. The LCD and the backlight are integrally held by an LCD holder, and the LCD holder is attached to a fixing member. To the fixing member, a substrate for driving the prism and the backlight is fixed. Between a first surface of the prism and the LCD holder, a dustproof member is disposed so as to prevent dirt such as dust from adhering to the image emitting surface of the LCD and the first surface of the prism.

Furthermore, in a head-mounted display apparatus disclosed in JP-A-H9-318905, a virtual image forming unit is integrally housed inside an enclosure having a substantially trapezoidal shape as seen in a side view. The enclosure has, in the back face thereof located on the user side, an opening through which image light is emitted, the opening being substantially blocked with a lens or a transparent plate.

However, the technique disclosed in JP-A-H11-296095, although it helps keep the inside of the image display portion dust free, makes the display apparatus as a whole large and heavy, making it difficult for the user to use it for a long time. On the other hand, in the technique disclosed in JP-A-H9-318905, the enclosure and the lens are simply joined together, making the joint between them vulnerable to dust and water.

As described above, making the conventional image display apparatus having see-through characteristics and the HMD provided with such a image display apparatus resistant to dust and water undesirably entails an increase in size and weight.

### SUMMARY OF THE INVENTION

An object of the present invention is to provide an image display apparatus that has resistance to dust and water, that is compact and lightweight, and that has see-through characteristics. Another object of the present invention is to provide a head-mounted display provided with such an image display apparatus.

To achieve the above objects, according to one aspect of the present invention, an image display apparatus is provided with: a display device displaying an image; a prism guiding light of the image displayed by the display device to an optical pupil, and transmitting outside light such that an outside world can be viewed therethrough; and an enclosure housing and holding the display device and part of the prism. Here, a first sealing member is provided so as to make contact with a part around the prism where image light is not reflected and with the enclosure.

With this structure, the first sealing member fills the gap between the enclosure and the prism. This helps prevent water and dust from entering the gap, and eliminates the possibility of the sealing member interfering with the reflection of the image light.

Specifically, in the image display apparatus described above, the first sealing member may be provided so as to fill a gap between the enclosure and the prism.

Preferably, in the image display apparatus described above, the enclosure is composed of a plurality of components, and a second sealing member is provided along a joint where, of the plurality of components, components having an externally exposed portion are fitted together. This is because it is thereby possible to prevent water and dust from getting into an enclosure having a common structure through the gap between the enclosure components.

Preferably, the image display apparatus described above is further provided with: a cable electrically connected to the display device for feeding drive power and an image signal thereto; and a bushing allowing the cable to be placed therethrough for fixing the cable in place, and holding the cable by being sandwiched between the plurality of components of the enclosure, and the bushing and the second sealing member are integrally formed.

As a result of the bushing and the second sealing member being integrally formed, a simple structure is achieved. Furthermore, the bushing, the first sealing member, and the second sealing member may be integrally formed.

Preferably, the image display apparatus described above is further provided with: a cable electrically connected to the display device for feeding drive power and an image signal thereto; and a bushing allowing the cable to be placed therethrough for fixing the cable in place, and holding the cable by being sandwiched between the plurality of components of the enclosure, and the bushing and the first sealing member are integrally formed.

As a result of the bushing and the first sealing member being integrally formed, a simple structure is achieved.

Preferably, in the image display apparatus described above, the prism has a regulating portion for regulating a position of the first sealing member.

The regulating portion makes it easy to perform positioning of the prism at the time of assembly, and prevents movement of the prism in use. In addition, as a result of the movement of the prism being prevented, it is possible to prevent the first sealing member from making contact with the part of the prism where the image light is reflected.

According to another aspect of the present invention, an image display apparatus is provided with: a display device displaying an image; a prism guiding light of the image displayed by the display device to an optical pupil, and transmitting outside light such that an outside world can be viewed therethrough; and an enclosure housing and holding the display device and part of the prism. Here, the enclosure is composed of a plurality of components, of the plurality of components, a component having an externally exposed portion is composed of a third sealing member and an outer shape forming member, and, at least part of the third sealing member makes contact with a part around the prism where the image light is not reflected and a joint of the components having an externally exposed portion.

With this structure, the third sealing member of the enclosure fills the gap between the enclosure and the prism and the gap between the enclosure components. This helps prevent water and dust from entering the gap, and eliminates the possibility of the enclosure part that makes contact with the prism interfering with the reflection of the image light.

To achieve the above objects, according to still another aspect of the present invention, an image display apparatus is provided with: a display device displaying an image; a prism guiding light of the image displayed by the display device to an optical pupil, and transmitting outside light such that an outside world can be viewed therethrough; and an enclosure housing and holding the display device and part of the prism. Here, a fourth sealing member is provided so as to make contact with a part around the prism and with the enclosure, and a mirror coating is applied to a part of the prism where the fourth sealing member makes contact with the prism, the part where the image light is reflected.

With this structure, the fourth sealing member fills the gap between the enclosure and the prism. This helps prevent water and dust from entering the gap, and eliminates the possibility of the image light being absorbed by the sealing member because the image light is reflected by the mirror coating.

In the image display apparatus described above, a mirror coating may be applied to a part of the prism where the enclosure makes contact with the prism, the part where the image light is reflected.

In the image display apparatus described above, part of the fourth sealing member may be brought into contact with a part of the prism where the image light is not reflected.

With this structure, there is no need to apply a mirror coating to the prism part with which part of the fourth sealing member makes contact, because the image light is not reflected in that part.

Specifically, in the image display apparatus described above, the fourth sealing member may be provided so as to fill a gap between the enclosure and the prism.

Preferably, in the image display apparatus described above, the enclosure is composed of a plurality of components, and a fifth sealing member is provided along a joint where, of the plurality of components, components having an externally exposed portion are fitted together. This is because it is thereby possible to prevent water and dust from getting into an enclosure having a common structure through the gap between the enclosure components.

Preferably, the image display apparatus described above is further provided with: a cable electrically connected to the display device for feeding drive power and an image signal thereto; and a bushing allowing the cable to be placed therethrough for fixing the cable in place, and holding the cable by being sandwiched between the plurality of components of the enclosure, and the bushing and the fifth sealing member are integrally formed.

As a result of the bushing and the fifth sealing member being integrally formed, a simple structure is achieved.

Preferably, the image display apparatus described above is further provided with: a cable electrically connected to the display device for feeding drive power and an image signal thereto; and a bushing allowing the cable to be placed therethrough for fixing the cable in place, and holding the cable by being sandwiched between the plurality of components of the enclosure, and the bushing and the fourth sealing member are integrally formed.

As a result of the bushing and the fourth sealing member being integrally formed, a simple structure is achieved. Furthermore, the bushing, the fourth sealing member, and the fifth sealing member may be integrally formed.

Preferably, in the image display apparatus described above, the prism has a regulating portion for regulating a position of the fourth sealing member.

The regulating portion makes it easy to perform positioning of the prism at the time of assembly, and prevents movement of the prism in use. In addition, as a result of the movement of the prism being prevented, it is possible to prevent the fourth sealing member from making contact with the part of the prism where the image light is reflected.

According to still another aspect of the present invention, an image display apparatus is provided with: a display device displaying an image; a prism guiding light of the image displayed by the display device to an optical pupil, and transmitting outside light such that an outside world can be viewed therethrough; and an enclosure housing and holding the display device and part of the prism. Here, the enclosure is composed of a plurality of components, of the plurality of components, a component having an externally exposed portion is composed of a sixth sealing member and an outer shape forming member, at least part of the sixth sealing member makes contact with a part around the prism and a joint of the components having an externally exposed portion, and a mirror coating is applied to a part of the prism where the enclosure makes contact with the prism, the part where the image light is reflected.

With this structure, the sixth sealing fills the gap between the enclosure and the prism and the gap between the enclosure components. This helps prevent water and dust from entering the gap, and eliminates the possibility of the image light being absorbed by the enclosure part that makes contact with the prism because the image light is reflected by the mirror coating.

Preferably, the image display apparatus described above is further provided with a volume-phase hologram optical element, and the hologram optical element diffraction-reflects the image light emergent from the display device and directs the image light to the optical pupil, and transmits the outside light to direct the outside light to the optical pupil.

The hologram optical element makes it easy to view the outside world while watching a bright image.

Preferably, in the image display apparatus described above, the prism includes a first transparent substrate that, on one hand, totally reflects the image light emergent from the display device inside the first transparent substrate so as to eventually direct the image light to the optical pupil, and, on the other hand, transmits the outside light to direct the outside light to the optical pupil, and a second transparent substrate for cancelling refraction that the outside light suffers when transmitted through the first transparent substrate.

With this structure, it is possible to view a bright image and a bright and natural outside world. In addition, as a result of the hologram optical element not being exposed, it is easy to handle the hologram optical element.

According to still another aspect of the present invention, a head-mounted display is provided with any one of the image display apparatuses described above and a supporting member supporting the image display apparatus in front of a viewer's eye. This makes possible mounting on the head.

Preferably, in the head-mounted display described above, the supporting member includes a pair of temples, each making contact with a temporal region of the viewer, a frame that pivotally supports the temples and supports the image display apparatus, and nose pads that are brought into contact with a nose of the viewer. This makes it possible to wear the head-mounted display like eyeglasses.

According to the present invention, the use of the sealing member makes it possible to fill the gap between the enclosure and the prism and the gap in the joint of the enclosure components without incurring any increase in size and weight, and thereby makes the apparatus resistant to water and dust.

### BRIEF DESCRIPTION OF THE DRAWINGS

FIG. 1 is a perspective view showing an outline of the structure of a HMD according to an embodiment of the present invention;

FIG. 2 is a side view of the HMD worn by the viewer;

FIG. 3 is a sectional view showing an outline of the structure of the image display apparatus provided in the HMD;

FIG. 4 is an exploded perspective view of the image display apparatus;

FIG. 5 is a sectional view showing an outline of the structure of the image display apparatus of Example 2;

FIG. 6 is an exploded perspective view of the image display apparatus shown in FIG. 5;

FIG. 7 is a sectional view showing an outline of the structure of the image display apparatus of Example 3;

FIG. 8 is an exploded perspective view of the image display apparatus shown in FIG. 7;

FIG. 9 is a sectional view showing an outline of the structure of the image display apparatus of Example 4;

FIG. 10 is a sectional view showing an outline of the structure of the image display apparatus of Example 5; and

FIG. 11 is an exploded perspective view of the image display apparatus shown in FIG. 10.

### DETAILED DESCRIPTION OF PREFERRED EMBODIMENTS

### 1. HMD

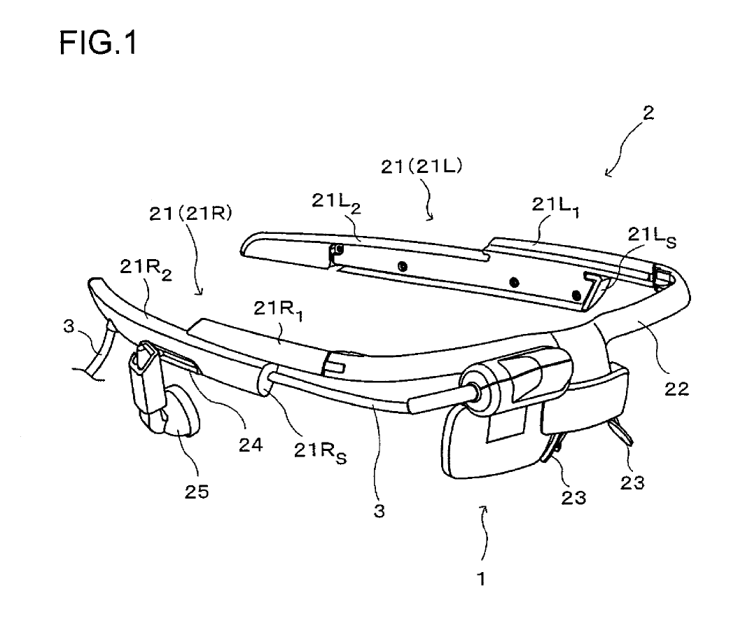

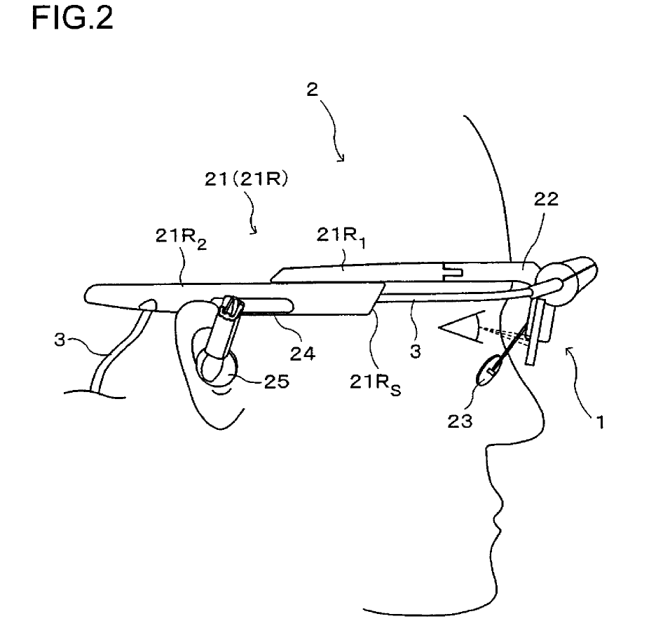

FIG. 1 is a perspective view showing an outline of the structure of a HMD according to an embodiment, and FIG. 2 is a side view of the HMD worn by the viewer. The HMD is composed of an image display apparatus 1, a supporting member 2, and a cable 3.

The image display apparatus 1 displays an image and presents it to the viewer. The supporting member 2 supports the image display apparatus 1 in front of the viewer's eye. In this embodiment, the supporting member 2 supports the image display apparatus 1 in such a way that the image display apparatus 1 is positioned in front of the viewer's right eye. However, it is also possible to provide two image display apparatuses 1, and support them in such a way that they are positioned in front of the eyes. In either case, as a result of the image display apparatus 1 being supported by the supporting member 2, the viewer is allowed to view an image displayed by the image display apparatus 1 with both hands free. The cable 3 connects between an external control portion and the image display apparatus 1, and feeds at least drive power and an image signal supplied from the control portion to the image display apparatus 1. Hereinafter, the image display apparatus 1 and the supporting member 2 will be described in detail.

### 2. Image Display Apparatus

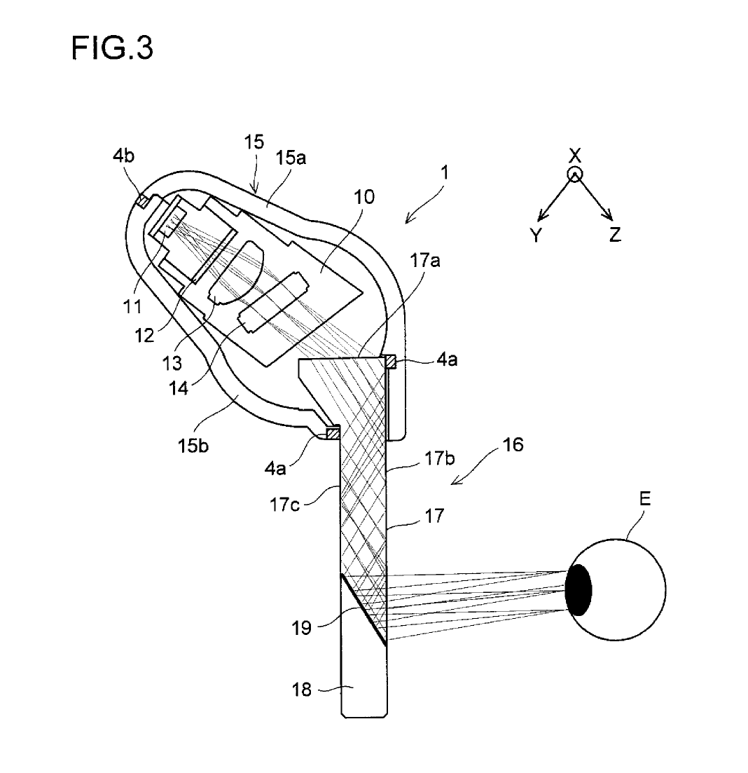

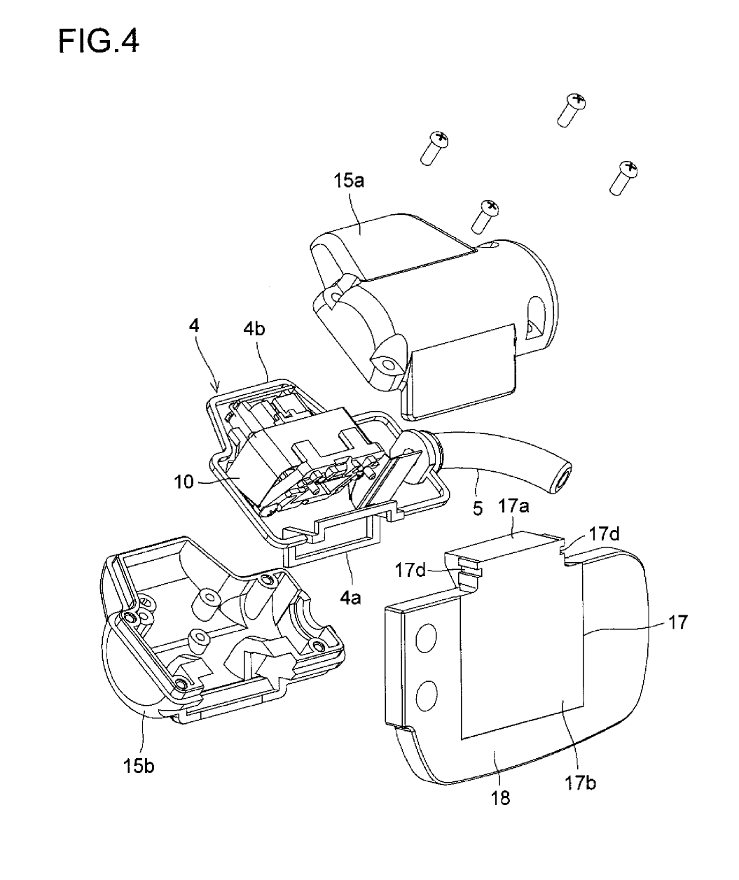

FIG. 3 is a sectional view showing an outline of the structure of the image display apparatus 1. FIG. 4 is an exploded perspective view of the image display apparatus 1 shown in FIG. 3. The image display apparatus 1 has a light source 11, a unidirectional diffuser plate 12, a focusing lens 13, a display device 14, and an eyepiece optical system 16. The light source 11, the unidirectional diffuser plate 12, the focusing lens 13, and the display device 14 are housed inside an enclosure 15 as a unit 10, and part of the eyepiece optical system 16 (part of an eyepiece prism 17, which will be described later) is also placed inside the enclosure 15. The cable 3 described above is placed through the enclosure 15, such that the light source 11 and the display device 14 are supplied with the drive power or image signal.

For the sake of convenience, the different directions mentioned in the following description are defined as follows. The axis optically connecting between the center of the display area of the display device 14 and the center of the optical pupil E formed by the eyepiece optical system 16 is called the optical axis. Assuming that the optical path from the light source 11 to the optical pupil E is straightened, the direction of the optical axis is called the Z-direction. The direction perpendicular to the optical-axis-incidence plane of a hologram optical element 19, which will be described later, provided in the eyepiece optical system 16 is called the X-direction, and the direction perpendicular to the ZX-plane is called the Y-direction. Here, the “optical-axis-incidence plane” of the hologram optical element 19 denotes the plane that includes both the optical axis of the light incident on the hologram optical element 19 and the optical axis of the light reflected therefrom, which is to say the YZ-plane. In the following description, the optical-axis-incidence plane is also referred to simply as the “incidence plane”. In this embodiment, whether a value is positive or negative is of no significance in any of the X-, Y-, and Z-directions.

The light source 11 illuminates the display device 14, and is built with, for example, an RGB composite LED that emits light in three wavelength bands of 462±12 nm (B (blue) light), 525±17 nm (G (green) light), and 635±11 nm (R (red) light), as given in terms of the light intensity peak wavelength combined with the half peak light intensity wavelength width. As a result of the light source 11 emitting light in predetermined wavelength widths in this way, the image light obtained by illuminating the display device 14 has predetermined wavelength widths. Thus, when the image light is diffracted by the hologram optical element 19, which will be described later, at the position of the optical pupil E, the viewer can view the image over the entire viewing angle. The peak wavelengths of the light source 11 for the different colors are set near the peak wavelengths of the diffraction efficiency, which will be described later, of the hologram optical element 19, and this leads to enhanced light use efficiency.

Built with an LED that emits RGB light, the light source 11 can be realized inexpensively, and, as it illuminates the display device 14, allows it to display a color image, making it possible to present the viewer with the color image. Moreover, since individual LEDs have narrow light emission wavelengths, using a plurality of them makes it possible to display a bright image with accurate color reproduction.

The unidirectional diffuser plate 12 diffuses the light emitted from the light source 11 at different degrees of diffusion in different directions. More specifically, the unidirectional diffuser plate 12 diffuses the incident light at about 40° in the X-direction and at about 0.5° in the Y-direction. Incidentally, the unidirectional diffuser plate 12 may be omitted.

The focusing lens 13 is built with a cylinder lens that focuses in the Y-direction the light diffused by the unidirectional diffuser plate 12, and is so arranged that the diffused light forms the optical pupil E efficiently.

The display device 14 displays an image by modulating the light emitted from the light source 11 according to image data, and is built with a transmission-type liquid crystal display device that has pixels arrayed in a matrix to form a region that transmits light. The display device 14 is arranged with the longer and shorter sides of its rectangular display area aligned with the X- and Y-directions respectively. The display device 14 may be of a reflection type. Usable as the display device 14 of a reflection type are, for example, a reflection-type liquid crystal display device and a DMD (Digital Micromirror Device, manufactured by Texas Instruments Incorporated).

The eyepiece optical system 16 is an enlargement optical system that presents the viewer with an enlarged virtual image of the image displayed by the display device 14 by guiding the light of the image displayed by the display device 14 to the optical pupil E, and is composed of an eyepiece prism 17 (first transparent substrate), a deflector prism 18 (second transparent substrate), and a hologram optical element 19.

The eyepiece prism 17, on one hand, totally reflects, between two opposite surfaces 17b and 17c, the image light entering through a surface 17a from the display device 14 to eventually direct the image light via the hologram optical element 19 to the viewer's pupil. The eyepiece prism 17, on the other hand, transmits outside light to direct it to the viewer's pupil. The eyepiece prism 17, and also the deflector prism 18, is formed of, for example, acrylic resin. The eyepiece prism 17 has the shape of a plane-parallel plate of which a bottom-end part is wedge-shaped by being formed increasingly thin toward the bottom end and of which a top-end part is formed increasingly thick toward the top end. The eyepiece prism 17 is joined to the deflector prism 18 with adhesive so as to sandwich the hologram optical element 19 arranged at the bottom end of the former.

The deflector prism 18 is a plane-parallel plate that is substantially U-shaped as seen in a front view (see FIGS. 1 and 4); when bonded to the eyepiece prism 17 at the bottom end and both sides thereof, the deflector prism 18 and the eyepiece prism 17 together form a substantially plane-parallel plate. Joining the deflector prism 18 to the eyepiece prism 17 helps prevent distortion in the outside world image that the viewer views through the eyepiece optical system 16.

Specifically, for example, if the deflector prism 18 is not joined to the eyepiece prism 17, outside light is refracted when it is transmitted through the wedge-shaped bottom-end part of the eyepiece prism 17, and this produces distortion in the outside world image viewed through the eyepiece prism 17. By contrast, when the deflector prism 18 is joined to the eyepiece prism 17 to form an integral substantially plane-parallel plate, the refraction that outside light suffers when transmitted through the wedge-shaped bottom-end part of the eyepiece prism 17 is canceled by the deflector prism 18. This helps prevent distortion in the outside world image viewed on a see-through basis.

The two opposite surfaces of the eyepiece prism 17 and the deflector prism 18 may be flat or curved. Giving the eyepiece prism 17 and the deflector prism 18 curved surfaces allows the eyepiece optical system 16 to function as an eyesight correcting lens.

The hologram optical element 19 is a volume-phase reflection hologram that diffraction-reflects the image light (light of wavelengths corresponding to three primary colors) emergent from the display device 14 and directs it to the optical pupil E, so that an enlarged image displayed by the display device 14 is, as a virtual image, directed to the viewer's pupil. The hologram optical element 19 is, for example, so fabricated as to diffract (reflect) light in three wavelength bands of 465±5 nm (B (blue) light), 521±5 nm (G (green) light), and 634±5 nm (R (red) light), as given in terms of the diffraction efficiency peak wavelength combined with the half peak diffraction efficiency wavelength width. Here, the diffraction efficiency peak wavelength is the wavelength at which diffraction efficiency is at a peak, and the half peak diffraction efficiency wavelength width is the wavelength width within which diffraction efficiency remains equal to or larger than half the peak of diffraction efficiency.

The reflection hologram optical element 19 exhibits high wavelength selectivity, and thus diffraction-reflects only light in the above wavelength bands (near the exposure wavelengths). Accordingly, the hologram optical element 19 transmits outside light containing wavelengths other than those it diffraction-reflects, and thus exhibits high transmittance to outside light.

Moreover, the hologram optical element 19 has an axis-asymmetric positive optical power; that is, the hologram optical element 19 has a function equivalent to that of an aspherical concave mirror having a positive optical power. This increases the flexibility of the arrangement of the individual optical elements constituting the apparatus, thereby making its miniaturization easier, and makes it possible to present the viewer with an image with satisfactorily corrected aberrations.

The enclosure 15 is built with an upper enclosure (“first enclosure”) 15a and a lower enclosure (“second enclosure”) 15b, with the former being fitted to the latter with screws. Instead, three or more parts may be fitted together to form the enclosure 15. Between the first enclosure 15a and the second enclosure 15b and between the enclosure 15 and the eyepiece prism 17, a gasket 4 serving as a sealing member is provided. The gasket 4 is composed of a first gasket (first sealing member) 4a located between the enclosure 15 and the eyepiece prism 17 and a second gasket (second sealing member) 4b located between the first enclosure 15a and the second enclosure 15b, the first gasket 4a and the second gasket 4b being integrated together.

The first gasket 4a is provided so as to make contact with the part around the eyepiece prism 17 where the image light is not reflected and with the enclosure 15; specifically, the first gasket 4a is provided so as to fill the gap between the enclosure 15 and the eyepiece prism 17. The first gasket 4a fills the gap between the enclosure 15 and the eyepiece prism 17, preventing water and dust from entering the gap.

If the first gasket 4a is provided in the part of the eyepiece prism 17 where the image light is reflected, part of the image light that is supposed to be reflected is absorbed by the first gasket 4a, making it impossible to achieve a desired image. Thus, the part of the eyepiece prism 17 where the image light is reflected is prevented from coming in contact with the gasket 4 and the enclosure 15; that is, a layer of air is provided in that part.

It is preferable that the part of the eyepiece prism 17 placed inside the enclosure 15, the part where the image light is not incident or reflected, be colored black or similar color. This is because it is thereby possible to achieve a clear image by absorbing unnecessary scattered light. It is also effective to color the first gasket 4a black or similar color, or to use the first gasket 4a having a surface colored black or similar color, the surface where the first gasket 4a makes contact with the eyepiece prism 17.

The eyepiece prism 17 has, on both sides thereof, grooves 17d serving as a regulating portion for regulating the position of the first gasket 4a. The presence of the grooves 17d produces the following advantages. The side portions of the first gasket 4a fit the grooves 17d, making it easy to perform positioning of the eyepiece prism 17 at the time of assembly, and preventing movement of the eyepiece prism 17 in use. In addition, as a result of the movement of the eyepiece prism 17 being prevented, it is possible to prevent the first gasket 4a from making contact with the part of the eyepiece prism 17 where the image light is reflected. Incidentally, forming at least one groove 17d produces the above advantages. The shape of the regulating portion is not limited to the groove, but may be otherwise as long as the regulating portion can regulate the position of the first gasket 4a. For example, the regulating portion may be formed into the shape of a ridge by removing one of the walls of the groove.

The second gasket 4b is provided along the joint of the enclosure components (in this example, two of a plurality of enclosure components) having an externally exposed portion. The second gasket 4b fills the gap between the enclosure components having an externally exposed portion, preventing water and dust from entering the gap. Moreover, a bushing 5 that allows the cable 3 to be placed therethrough for fixing it in place and that holds the cable 3 by being sandwiched between the first enclosure 15a and the second enclosure 15b is formed integrally with the second gasket 4b. The bushing 5 prevents the cable 3 from being broken when it is bent smaller than its minimum bend radius. As a result of the bushing 5 and the second gasket 4b being integrally formed, a simple structure is achieved. Incidentally, forming the bushing 5 separately from the second gasket 4b poses no problem at all.

It is preferable that the gasket 4 and the bushing 5 be formed of an elastic material such as rubber due to its ease of processing, wearability, and resistance to water and dust. Other materials for the gasket 4 include an adhesive and caulking.

As described above, the use of the gasket 4 makes it possible to fill the gap between the enclosure 15 and the eyepiece prism 17 and the gap in the joint of the enclosure components without incurring any increase in size and weight, and thereby makes the apparatus resistant to water and dust.

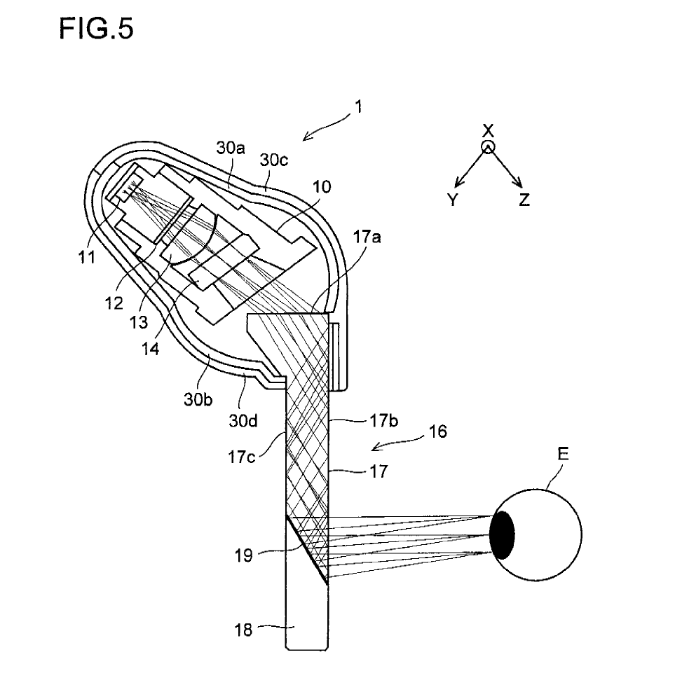

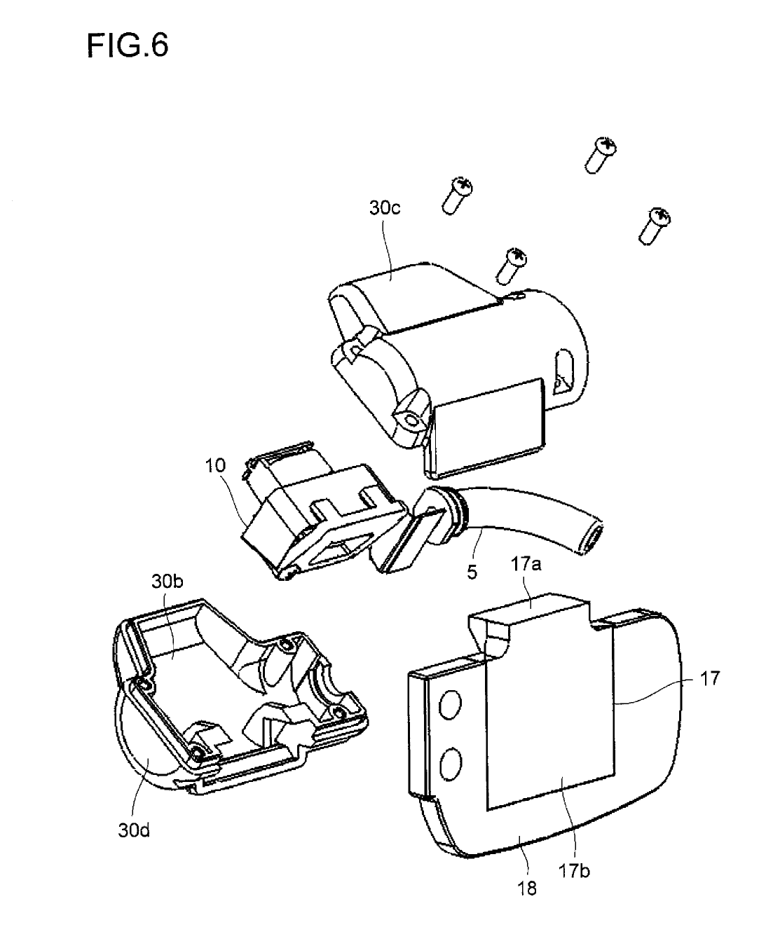

Next, four other structures of the enclosure will be described. FIG. 5 is a sectional view showing an outline of the structure of the image display apparatus 1 of Example 2, and FIG. 6 is an exploded perspective view of the image display apparatus 1 shown in FIG. 5. In the following description, only differences from the above embodiment are explained, and the explanations of such component parts as are found also in the above embodiment will not be repeated as already given there.

An enclosure 30 is built with an upper enclosure (“third enclosure”) 30a and a lower enclosure (“fourth enclosure”) 30b, which are outer shape forming members, and an upper enclosure (“fifth enclosure”) 30c and a lower enclosure (“sixth enclosure”) 30d, which are sealing members covering the third enclosure 30a and the fourth enclosure 30b. The third enclosure 30a and the fourth enclosure 30b are fitted together, and the fifth enclosure 30c and the sixth enclosure 30d are fitted together. Here, the third and fourth enclosures 30a and 30b are made of plastic, and the fifth and sixth enclosures (third sealing member) 30c and 30d are made of an elastic material such as rubber. The fifth and sixth enclosures 30c and 30d are formed so as to cover the entire outer surface of the third and fourth enclosures 30a and 30b. As a result, the gap between the third and fourth enclosures 30a and 30b is covered with the fifth and sixth enclosures 30c and 30d, preventing water and dust from entering the gap.

Incidentally, providing the fifth and sixth enclosures 30c and 30d so as to cover the inner surface of the third and fourth enclosures 30a and 30b poses no problem at all.

Each of the third to sixth enclosures 30a to 30d is so structured that it makes contact, at one edge thereof, with the part around the eyepiece prism 17 where the image light is not reflected. This fills the gap between the eyepiece prism 17 and the enclosure 30, preventing water and dust from entering the gap. Although the bushing 5 here is provided separately from the enclosure 30, the bushing 5 may be formed integrally with the first enclosure 30c or the sixth enclosure 30d. Doing so makes it possible to achieve a simple structure.

The use of the enclosure 30 colored black or similar color, or the enclosure 30 having a surface colored black or similar color, the surface where the enclosure 30 makes contact with the eyepiece prism 17, is effective in achieving a clear image by absorbing unnecessary scattered light.

As described above, the use of the fifth and sixth enclosures 30c and 30d makes it possible to fill the gap between the enclosure 30 and the eyepiece prism 17 and the gap in the joint of the enclosure components without incurring any increase in size and weight, and thereby makes the apparatus resistant to water and dust.

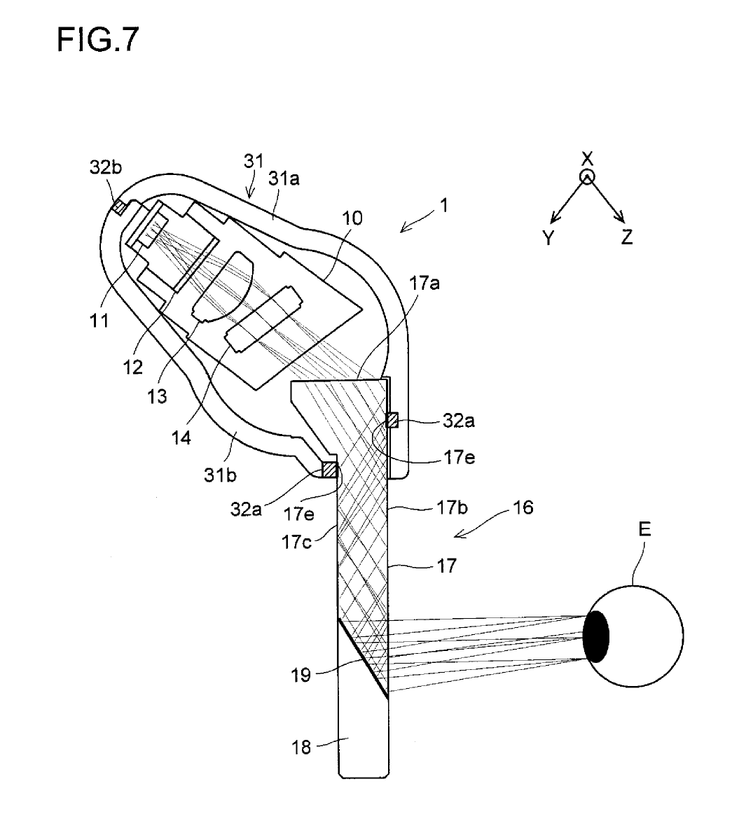

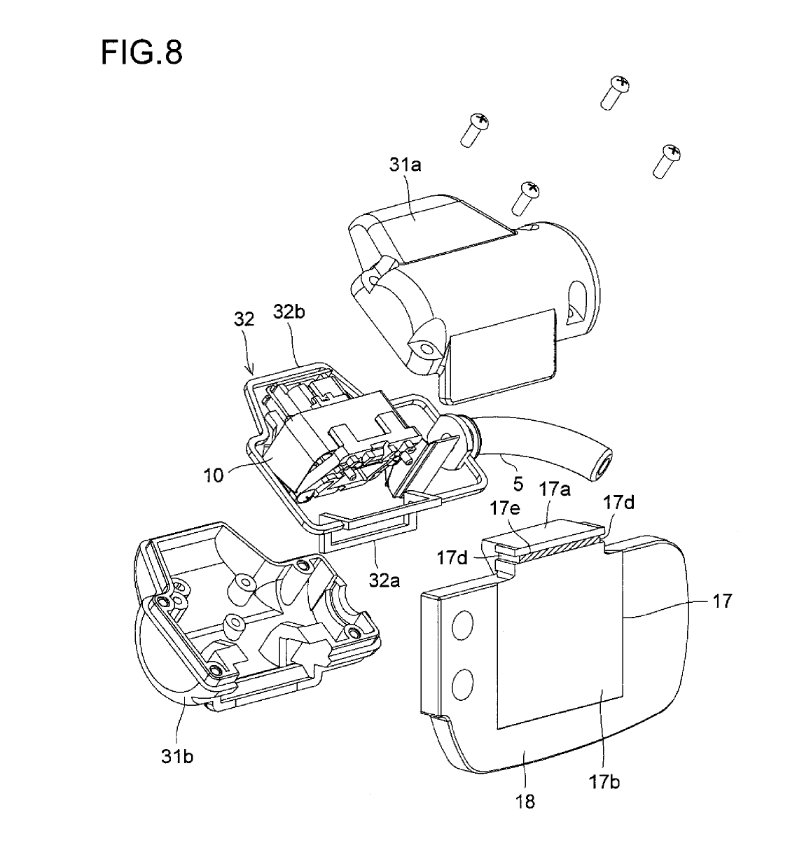

FIG. 7 is a sectional view showing an outline of the structure of the image display apparatus 1 of Example 3, and FIG. 8 is an exploded perspective view of the image display apparatus 1 shown in FIG. 7.

An enclosure 31 is built with an upper enclosure (“seventh enclosure”) 31a and a lower enclosure (“eighth enclosure”) 31b, with the former being fitted to the latter with screws. Instead, three or more parts may be fitted together to form the enclosure 31. Between the seventh enclosure 31a and the eighth enclosure 31b and between the enclosure 31 and the eyepiece prism 17, a gasket 32 is provided. The gasket 32 is composed of a third gasket (fourth sealing member) 32a located between the enclosure 31 and the eyepiece prism 17 and a fourth gasket (fifth sealing member) 32b located between the first enclosure 31a and the second enclosure 31b, the third gasket 32a and the fourth gasket 32b being integrated together.

The third gasket 32a is provided so as to make contact with the part around the eyepiece prism 17 and with the enclosure 31; specifically, the third gasket 32a is provided so as to fill the gap between the enclosure 31 and the eyepiece prism 17. The third gasket 32a fills the gap between the enclosure 31 and the eyepiece prism 17, preventing water and dust from entering the gap.

A mirror coating 17e is applied to the part of the eyepiece prism 17 where the third gasket 32a makes contact with the eyepiece prism 17, the part where the image light is reflected. Though not adopted in this embodiment, it is also possible to apply a mirror coating to the part, if any, of the eyepiece prism 17 where the enclosure 31 makes contact with the eyepiece prism 17, the part where the image light is reflected. It is to be noted that the mirror coating 17e may be applied to the entire part of the eyepiece prism 17 placed inside the enclosure 31, the part where the image light is reflected.

The mirror coating 17e allows the image light to be totally reflected, making it possible to achieve a desired image. Without the mirror coating 17e, part of the image light that is supposed to be reflected is absorbed by the third gasket 32a, making it impossible to achieve a desired image. Thus, the other part of the eyepiece prism 17 where the image light is reflected, the part where no mirror coating is applied, is prevented from coming in contact with the gasket 32 and the enclosure 31; that is, a layer of air is provided in that part.

Here, usable as a material for the mirror coating 17e are, for example, silicon dioxide, silicon monoxide, aluminum oxide, zirconium oxide, titanium oxide, cerium oxide, lanthanum oxide, magnesium oxide, tin oxide, tantalum pentoxide, yttrium oxide, zinc oxide, magnesium fluoride, and lanthanum fluoride. Of these materials, one may be used singly or two or more may be used in combination. Also, usable as a material for the mirror coating 17e are, for example, organo polysiloxane resin and a mixture containing it.

The mirror coating 17e is formed by, for example, vacuum evaporation, sputtering, ion plating, or solution technique. It is preferable to perform pretreatment such as activated gas treatment, ion treatment, or chemical treatment before film formation with the aim of enhancing the adhesion of the mirror coating 17e.

It is preferable that the part of the eyepiece prism 17 placed inside the enclosure 31, the part where the image light is not incident or reflected, be colored black or similar color. This is because it is thereby possible to achieve a clear image by absorbing unnecessary scattered light.

The eyepiece prism 17 has, on both sides thereof, grooves 17d serving as a regulating portion for regulating the position of the third gasket 32a. The presence of the grooves 17d produces the following advantages. The side portions of the third gasket 32a fit the grooves 17d, making it easy to perform positioning of the eyepiece prism 17 at the time of assembly, and preventing movement of the eyepiece prism 17 in use. Incidentally, forming at least one groove 17d produces the above advantages. The shape of the regulating portion is not limited to the groove, but may be otherwise as long as the regulating portion can regulate the position of the third gasket 32a. For example, the regulating portion may be formed into the shape of a ridge by removing one of the walls of the groove.

The fourth gasket 32b is provided along the joint of the enclosure components (in this example, two of a plurality of enclosure components) having an externally exposed portion. The fourth gasket 32b fills the gap between the enclosure components having an externally exposed portion, preventing water and dust from entering the gap. Moreover, the bushing 5 that allows the cable 3 to be placed therethrough for fixing it in place and that holds the cable 3 by being sandwiched between the seventh enclosure 31a and the eighth enclosure 31b is formed integrally with the fourth gasket 32b. The bushing 5 prevents the cable 3 from being broken when it is bent smaller than its minimum bend radius. As a result of the bushing 5 and the fourth gasket 32b being integrally formed, a simple structure is achieved. Incidentally, forming the bushing 5 separately from the fourth gasket 32b poses no problem at all.

It is preferable that the gasket 32 and the bushing 5 be formed of an elastic material such as rubber due to its ease of processing, wearability, and resistance to water and dust. Other materials for the gasket 32 include an adhesive and caulking.

As described above, the use of the gasket 32 makes it possible to fill the gap between the enclosure 31 and the eyepiece prism 17 and the gap in the joint of the enclosure components without incurring any increase in size and weight, and thereby makes the apparatus resistant to water and dust.

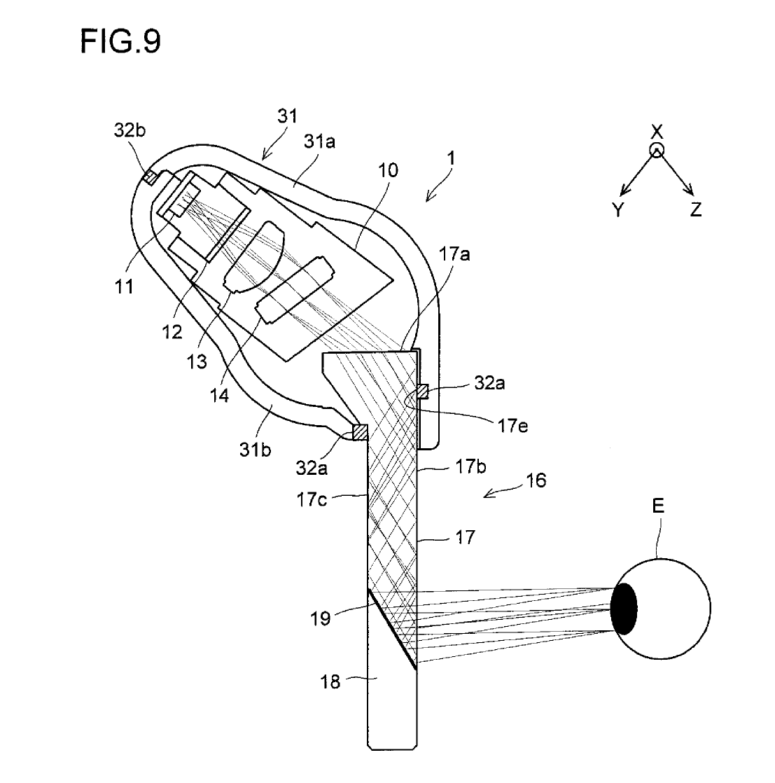

Incidentally, part of the third gasket 32a may be brought into contact with the part of the eyepiece prism 17 where the image light is not reflected. FIG. 9 is a sectional view showing an outline of the structure of the image display apparatus 1 of Example 4. The structure shown in FIG. 9 differs from that shown in FIG. 7 in that the third gasket 32a making contact with the surface 17c of the eyepiece prism 17 is brought into contact with the part of the eyepiece prism 17 where the image light is not reflected.

In this case, there is no need to apply a mirror coating to the part of the surface 17c of the eyepiece prism 17 with which the third gasket 32a makes contact, because the image light is not reflected in that part. Instead, it is preferable that that part be colored black or similar color. This is because it is thereby possible to achieve a clear image by absorbing unnecessary scattered light. It is also effective to color the third gasket 32a black or similar color, or to use the third gasket 32a having a surface colored black or similar color, the surface where the third gasket 32a makes contact with the eyepiece prism 17.

The above description deals with a case in which the third gasket 32a making contact with the surface 17c of the eyepiece prism 17 is brought into contact with the part of the eyepiece prism 17 where the image light is not reflected. However, the third gasket 32a making contact with the surface 17b of the eyepiece prism 17 may be brought into contact with the part of the eyepiece prism 17 where the image light is not reflected.

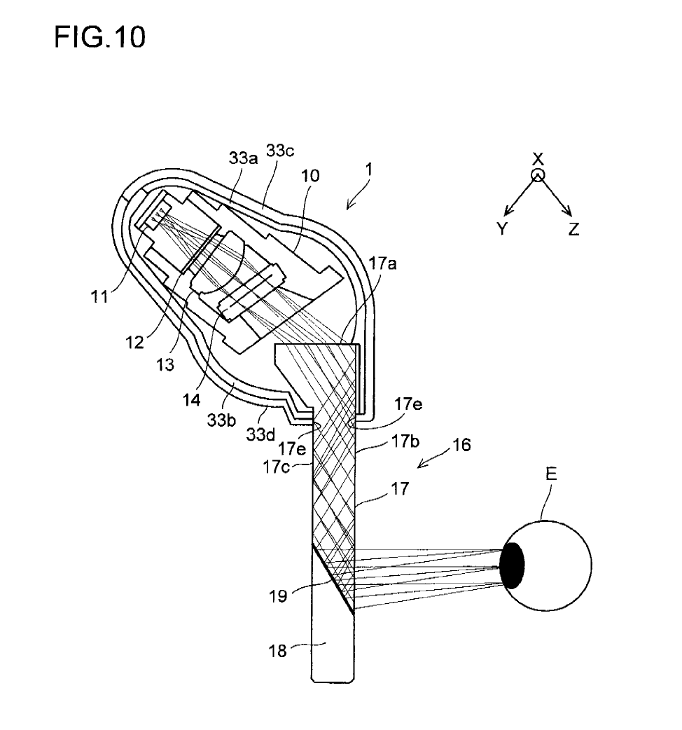

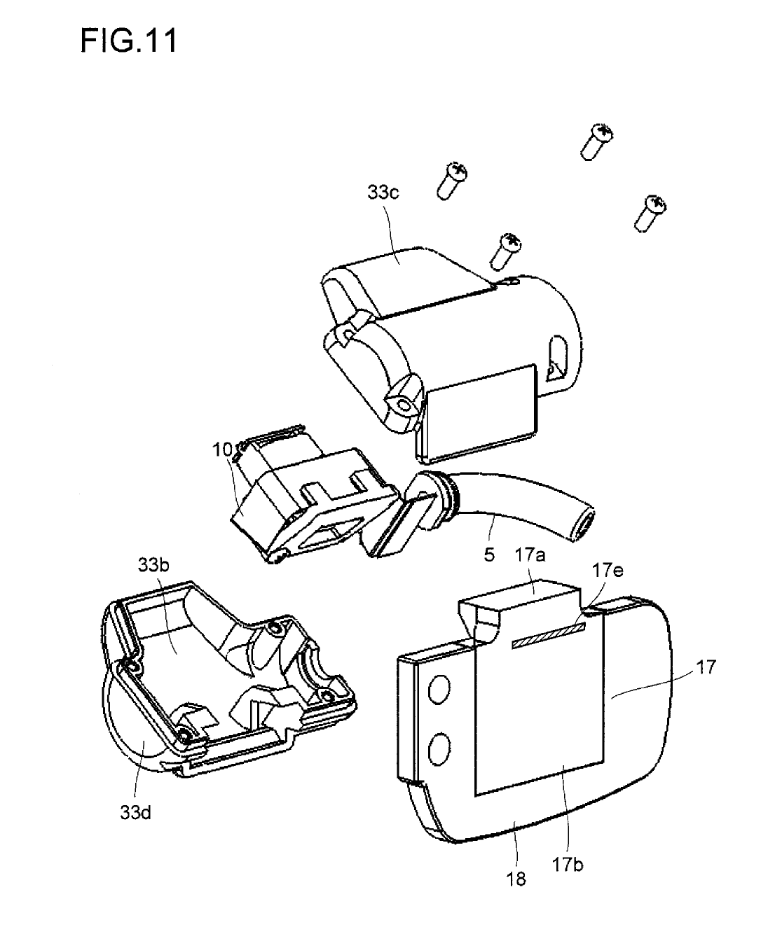

FIG. 10 is a sectional view showing an outline of the structure of the image display apparatus 1 of Example 5, and FIG. 11 is an exploded perspective view of the image display apparatus 1 shown in FIG. 10.

An enclosure 33 is built with an upper enclosure (“ninth enclosure”) 33a and a lower enclosure (“tenth enclosure”) 33b, which are outer shape forming members, and an upper enclosure (“eleventh enclosure”) 33c and a lower enclosure (“twelfth enclosure”) 33d, which are sealing members covering the ninth enclosure 33a and the tenth enclosure 33b. The ninth enclosure 33a and the tenth enclosure 33b are fitted together, and the eleventh enclosure 33c and the twelfth enclosure 33d are fitted together. Here, the ninth and tenth enclosures 33a and 33b are made of plastic, and the eleventh and twelfth enclosures (sixth sealing member) 33c and 33d are made of an elastic material such as rubber. The eleventh and twelfth enclosures 33c and 33d are formed so as to cover the entire outer surface of the ninth and tenth enclosures 33a and 33b. As a result, the gap between the ninth and tenth enclosures 33a and 33b is covered with the eleventh and twelfth enclosures 33c and 33d, preventing water and dust from entering the gap.

Incidentally, providing the eleventh and twelfth enclosures 33c and 33d so as to cover the inner surface of the ninth and tenth enclosures 33a and 33b poses no problem at all.

Each of the ninth to twelfth enclosures 33a to 33d is so structured that it makes contact, at one edge thereof, with the part around the eyepiece prism 17 where the image light is reflected. This fills the gap between the eyepiece prism 17 and the enclosure 33, preventing water and dust from entering the gap.

The mirror coating 17e is applied to the part of the eyepiece prism 17 with which the edge of the enclosure 33 makes contact, the part where the image light is reflected. Instead, the mirror coating 17e may be applied to the entire part of the eyepiece prism 17 placed inside the enclosure 33, the part where the image light is reflected. The mirror coating 17e allows the image light to be totally reflected, making it possible to achieve a desired image.

Although the bushing 5 here is provided separately from the enclosure 33, the bushing 5 may be formed integrally with the eleventh enclosure 33c or the twelfth enclosure 33d. Doing so makes it possible to achieve a simple structure.

As described above, the use of the eleventh and twelfth enclosures 33c and 33d makes it possible to fill the gap between the enclosure 33 and the eyepiece prism 17 and the gap in the joint of the enclosure components without incurring any increase in size and weight, and thereby makes the apparatus resistant to water and dust.

Next, the operation of the image display apparatus 1 will be described. The light emitted from the light source 11 is diffused by the unidirectional diffuser plate 12, is then focused by the focusing lens 13, and then enters the display device 14. The light that has entered the display device 14 is modulated pixel by pixel according to image data, and emerges therefrom as image light. Thus, the display device 14 displays a color image.

The image light from the display device 14 then enters, in the eyepiece optical system 16, the eyepiece prism 17 through the top-end surface (surface 17a) thereof, is then reflected a plurality of times between the two opposite surfaces 17b and 17c, and then strikes the hologram optical element 19. The light that has struck the hologram optical element 19 is reflected thereon, and is then transmitted through the surface 17b, to eventually reach the optical pupil E. At the position of the optical pupil E, the viewer can view an enlarged virtual image of the image displayed by the display device 14.

On the other hand, the eyepiece prism 17, the deflector prism 18, and the hologram optical element 19 transmit almost all outside light; thus, through these, the viewer can view an outside world image. As a result, the virtual image of the image displayed by the display device 14 is viewed in a form superimposed on part of the outside world image.

As described above, in the image display apparatus 1, the image light emergent from the display device 14 is guided by total reflection inside the eyepiece prism 17 so as to be directed via the hologram optical element 19 to the viewer's pupil. This allows the eyepiece prism 17 and the deflector prism 18 to have a thickness of about 3 mm like a common eyeglasses lens, and thus helps make the image display apparatus 1 compact and lightweight. Moreover, the use of the eyepiece prism 17, inside which the image light from the display device 14 is totally reflected, helps secure high transmittance to outside light, and thus makes it possible to present the viewer with a bright outside world image.

Moreover, since the volume-phase reflection hologram optical element 19 has narrow half peak diffraction efficiency wavelength widths and thus offers high diffraction efficiency, its use makes it possible to present a bright image with high color purity, and also offers high transmittance to outside light, allowing the viewer to view a bright outside world image.

Moreover, as will be understood from the foregoing, the hologram optical element 19 functions as a combiner that directs the image light from the display device 14 and outside light simultaneously to the viewer's pupil. Thus, the viewer can view, via the hologram optical element 19, the image presented by the display device 14 and an outside world image simultaneously. 3. Supporting member

Next, with reference to FIGS. 1 and 2, the supporting member 2 will be described.

The supporting member 2 has a temple 21 and a frame 22. The temple 21 is composed of a pair of temples 21R and 21L that are brought into contact with the viewer's temporal regions. The frame 22 pivotally supports the temples 21R and 21L, and supports the above-described image display apparatus 1. The frame 22 is substantially T-shaped. The temple 21 and the frame 22 are made of, for example, resin, and has flexibility. The frame 22 is provided with a pair of nose pads 23 that are brought into contact with the viewer's nose.

In this embodiment, the temple 21R is built as a single member into which a first temple portion 21R₁ and a second temple portion 21R₂ are integrated together. Likewise, the temple 21L is built as a single member into which a first temple portion 21L₁ and a second temple portion 21L₂ are integrated together. The first temple portions 21R₁ and 21L₁ and the second temple portions 21R₂ and 21L₂ are elongate in the front-back direction, and the second temple portions 21R₂ and 21L₂ are made slightly longer than the first temple portions 21R₁ and 21L₁.

The first temple portions 21R₁ and 21L₁ are each pivotally connected to the frame 22 at a corresponding one of the ends of the frame 22, and are located on the second temple portions 21R₂ and 21L₂, respectively, with the first temple portions 21R₁ and 21L₁ shifted forward relative to the second temple portions 21R₂ and 21L₂.

The second temple portions 21R₂ and 21L₂ are supported by the frame 22 via the first temple portions 21R₁ and 21L₁. The second temple portion 21R₂ has an earphone holding portion 24 that holds an earphone 25 in such a way that the earphone 25 can slide in the front-back direction. Thus, the viewer is allowed to listen to sounds with the earphone 25 being held by the earphone holding portion 24 (without inserting the earphone 25 into his/her ear).

The second temple portions 21R₂ and 21L₂ have exposed surfaces 21R_{S} and 21L_{S}, respectively, that face forward at a level that is different from the level at which the first temple portions 21R₁ and 21L₁ are supported by the frame 22. The cable 3 described above is passed through the second temple portion 21R₂, for example, emerges from the exposed surface 21R_{S}, and is then connected to the image display apparatus 1. By adopting such a connecting method, the following first to fourth effects can be obtained.

Firstly, since the cable 3 is connected to the image display apparatus 1 while being partly supported by the temple 21R (second temple portion 21R₂), unlike a case in which the cable 3 is directly connected to the image display apparatus 1, the weight of the cable 3 is not directly applied to the image display apparatus 1. As a result, even when the viewer uses the HMD for a long time, the viewer does not experience increased fatigue or discomfort. This helps ease strain on the viewer who uses the HMD for a long time.

In particular, in this embodiment, the temple 21R has a two-tiered structure consisting of the first temple portion 21R₁ and the second temple portion 21R₂. This ensures that the position in which the temple 21R is supported by the frame 22 (the position where the first temple portion 21R₁ and the frame 22 are connected together) is made different from the position of the exposed surface 21R_{S} in the height direction. This makes sure that the cable 3 can be pulled out of the second temple portion 21R₂ through the exposed surface 21R_{S} with the frame 22 and the first temple portion 21R₁ pivotally connected to each other, ensuring the adoption of the connecting method described above.

Secondly, since the temple 21R can support the cable 3 in a stable manner by making contact with the temporal region of the viewer, even when the cable 3 is supported by one temple, that is, the temple 21R, as in this embodiment, the viewer is allowed to wear the HMD with stability (without letting the HMD move back and forth and around).

Thirdly, since the cable 3 is passed through the exposed surface 21R_{S} of the temple 21R so as to be located in a position different from the position where the frame 22 is located in the height direction, there is no possibility that, when the temple 21R pivots at an end of the frame 22, the cable 3 becomes entwined with that end portion, and interferes with the movement of the temple 21R. This makes it possible to fold the temple 21R with ease.

Fourthly, since the cable 3 does not pass trough the frame 22, there is no need to make the frame 22 thick more than necessary. This allows the frame 22 to change shape according to the size of the viewer's head, allowing the viewer to wear the HMD with stability without any unpleasant sensation.

In addition, as shown in FIG. 2, the cable 3 is introduced into the second temple portion 21R₂ through a part thereof located behind the position where the second temple portion 21R₂ makes contact with the viewer's ear. This allows the cable 3 to hang down behind the viewer's ear, making it possible to maintain the weight balance between the front and back relative to the viewer's ear. This surely eases strain on the viewer. Furthermore, there is no possibility that the cable 3 obstructs the viewer's view in a lateral direction.

Moreover, since the first temple portion 21R₁ and the second temple portion 21R₂ are elongate in the front-back direction, and the first temple portion 21R₁ is connected to the second temple portion 21R₂ with the first temple portion 21R₁ shifted forward relative to the second temple portion 21R₂, it is possible to make the first temple portion 21R₁ and the second temple portion 21R₂ have a minimum thickness (height), and thereby make the temple 21R as a whole compact and lightweight. In addition, when the first temple portion 21R₁ is made to pivot at one end of the frame 22, the second temple portion 21R₂ lies closer to the frame 22 than the first temple portion 21R₁. This prevents the second temple portion 21R₂ from jutting outward, allowing for compact storage of the HMD.

Furthermore, since the first temple portion 21R₁ is located above the second temple portion 21R₂, when the HMD is mounted on the viewer's head (when the second temple portion 21R₂ is placed over the viewer's ear), the first temple portion 21R₁ is located above the viewer's eye. This allows the frame 22 connected to the first temple portion 21R₁ to be located above the viewer's eye at least from the front to the side of the viewer, making it possible to provide the viewer with a wide field of view. In addition, even when the viewer wears regular eyeglasses, the frame 22 of the HMD is out of the way of the temples or frames of the eyeglasses. This makes it easy to use the HMD while wearing the eyeglasses.

Incidentally, it is preferable that surfaces of the second temple portions 21R₂ and 21L₂ at which they make contact with the temporal region of the viewer be a flat or substantially flat surface. In this embodiment, as shown in FIG. 1, the above surfaces enclosed by the contour of the second temple portions 21R₂ and 21L₂ are flat surfaces. As a result, compared to line contact, the area of contact between the second temple portions 21R₂ and 21L₂ and the temporal region of the viewer is increased, allowing the viewer to wear the HMD with stability. In addition, the force exerted on the head is divided by the second temple portions 21R₂ and 21L₂, allowing the viewer to wear the HMD for a long time without any unpleasant sensation.

The image display apparatus and the head-mounted display of the present invention can be used particularly effectively in the products used in harsh environments, such as outdoors, that require resistance to water and dust.

What is claimed is:

1. An image display apparatus comprising:
a display device displaying an image;
a prism guiding light of the image displayed by the display device to an optical pupil, and transmitting outside light such that an outside world can be viewed therethrough; and
an enclosure housing and holding the display device and part of the prism,
wherein a first sealing member is provided so as to make contact with a part around the prism where image light is not reflected and with the enclosure.

2. The image display apparatus of claim 1,
wherein the first sealing member is provided so as to fill a gap between the enclosure and the prism.

3. The image display apparatus of claim 2,
wherein the enclosure is composed of a plurality of components,
wherein a second sealing member is provided along a joint where, of the plurality of components, components having an externally exposed portion are fitted together.

4. The image display apparatus of claim 3, further comprising:
a cable electrically connected to the display device for feeding drive power and an image signal thereto; and
a bushing allowing the cable to be placed therethrough for fixing the cable in place, and holding the cable by being sandwiched between the plurality of components of the enclosure,
wherein the bushing and the second sealing member are integrally formed.

5. The image display apparatus of claim 3, further comprising:
a cable electrically connected to the display device for feeding drive power and an image signal thereto; and
a bushing allowing the cable to be placed therethrough for fixing the cable in place, and holding the cable by being sandwiched between the plurality of components of the enclosure,
wherein the bushing, the first sealing member, and the second sealing member are integrally formed.

6. The image display apparatus of claim 1,
wherein the prism has a regulating portion for regulating a position of the first sealing member.

7. The image display apparatus of claim 1, further comprising:
a volume-phase hologram optical element,
wherein the hologram optical element diffraction-reflects the image light emergent from the display device and directs the image light to the optical pupil, and transmits the outside light to direct the outside light to the optical pupil.

8. The image display apparatus of claim 1,
wherein the prism includes
a first transparent substrate that, on one hand, totally reflects the image light emergent from the display device inside the first transparent substrate so as to eventually direct the image light to the optical pupil, and, on the other hand, transmits the outside light to direct the outside light to the optical pupil, and
a second transparent substrate for cancelling refraction that the outside light suffers when transmitted through the first transparent substrate.

9. A head-mounted display comprising:
the image display apparatus of claim 1; and
a supporting member supporting the image display apparatus in front of a viewer's eye.

10. The head-mounted display of claim 9,
wherein the supporting member includes
a pair of temples, each making contact with a temporal region of the viewer,
a frame that pivotally supports the temples and supports the image display apparatus, and
nose pads that are brought into contact with a nose of the viewer.

11. An image display apparatus comprising:
a display device displaying an image;
a prism guiding light of the image displayed by the display device to an optical pupil, and transmitting outside light such that an outside world can be viewed therethrough; and
an enclosure housing and holding the display device and part of the prism,
wherein
the enclosure is composed of a plurality of components,
of the plurality of components, a component having an externally exposed portion is composed of a third sealing member and an outer shape forming member,
at least part of the third sealing member makes contact with a part around the prism where the image light is not reflected and a joint of the components having an externally exposed portion.

12. The image display apparatus of claim 11, further comprising:
a volume-phase hologram optical element,
wherein the hologram optical element diffraction-reflects the image light emergent from the display device and directs the image light to the optical pupil, and transmits the outside light to direct the outside light to the optical pupil.

13. The image display apparatus of claim 11,
wherein the prism includes
a first transparent substrate that, on one hand, totally reflects the image light emergent from the display device inside the first transparent substrate so as to eventually direct the image light to the optical pupil, and, on the other hand, transmits the outside light to direct the outside light to the optical pupil, and
a second transparent substrate for cancelling refraction that the outside light suffers when transmitted through the first transparent substrate.

14. A head-mounted display comprising:
the image display apparatus of claim 11; and
a supporting member supporting the image display apparatus in front of a viewer's eye.

15. The head-mounted display of claim 14,
wherein the supporting member includes
a pair of temples, each making contact with a temporal region of the viewer,
a frame that pivotally supports the temples and supports the image display apparatus, and
nose pads that are brought into contact with a nose of the viewer.

16. An image display apparatus comprising:
a display device displaying an image;
a prism guiding light of the image displayed by the display device to an optical pupil, and transmitting outside light such that an outside world can be viewed therethrough; and
an enclosure housing and holding the display device and part of the prism,
wherein a fourth sealing member is provided so as to make contact with a part around the prism and with the enclosure,
wherein a mirror coating is applied to a part of the prism where the fourth sealing member makes contact with the prism, the part where the image light is reflected.

17. The image display apparatus of claim 16,
wherein a mirror coating is applied to a part of the prism where the enclosure makes contact with the prism, the part where the image light is reflected.

18. The image display apparatus of claim 16,
wherein part of the fourth sealing member is brought into contact with a part of the prism where the image light is not reflected.

19. The image display apparatus of claim 16,
wherein the fourth sealing member is provided so as to fill a gap between the enclosure and the prism.

20. The image display apparatus of claim 19,
wherein the enclosure is composed of a plurality of components,
wherein a fifth sealing member is provided along a joint where, of the plurality of components, components having an externally exposed portion are fitted together.

21. The image display apparatus of claim 20, further comprising:
a cable electrically connected to the display device for feeding drive power and an image signal thereto; and
a bushing allowing the cable to be placed therethrough for fixing the cable in place, and holding the cable by being sandwiched between the plurality of components of the enclosure,
wherein the bushing and the fifth sealing member are integrally formed.

22. The image display apparatus of claim 20, further comprising:
a cable electrically connected to the display device for feeding drive power and an image signal thereto; and
a bushing allowing the cable to be placed therethrough for fixing the cable in place, and holding the cable by being sandwiched between the plurality of components of the enclosure,
wherein the bushing, the fourth sealing member, and the fifth sealing member are integrally formed.

23. The image display apparatus of claim 16,
wherein the prism has a regulating portion for regulating a position of the fourth sealing member.

24. The image display apparatus of claim 16, further comprising:
a volume-phase hologram optical element,
wherein the hologram optical element diffraction-reflects the image light emergent from the display device and directs the image light to the optical pupil, and transmits the outside light to direct the outside light to the optical pupil.

25. The image display apparatus of claim 16,
wherein the prism includes
a first transparent substrate that, on one hand, totally reflects the image light emergent from the display device inside the first transparent substrate so as to eventually direct the image light to the optical pupil, and, on the other hand, transmits the outside light to direct the outside light to the optical pupil, and
a second transparent substrate for cancelling refraction that the outside light suffers when transmitted through the first transparent substrate.

26. A head-mounted display comprising:
the image display apparatus of claim 16; and
a supporting member supporting the image display apparatus in front of a viewer's eye.

27. The head-mounted display of claim 26,
wherein the supporting member includes
a pair of temples, each making contact with a temporal region of the viewer,
a frame that pivotally supports the temples and supports the image display apparatus, and
nose pads that are brought into contact with a nose of the viewer.

28. An image display apparatus comprising:
a display device displaying an image;
a prism guiding light of the image displayed by the display device to an optical pupil, and transmitting outside light such that an outside world can be viewed therethrough; and
an enclosure housing and holding the display device and part of the prism,
wherein
the enclosure is composed of a plurality of components,
of the plurality of components, a component having an externally exposed portion is composed of a sixth sealing member and an outer shape forming member,
at least part of the sixth sealing member makes contact with a part around the prism and a joint of the components having an externally exposed portion,
wherein a mirror coating is applied to a part of the prism where the enclosure makes contact with the prism, the part where the image light is reflected.

29. The image display apparatus of claim 28, further comprising:
a volume-phase hologram optical element,
wherein the hologram optical element diffraction-reflects the image light emergent from the display device and directs the image light to the optical pupil, and transmits the outside light to direct the outside light to the optical pupil.

30. The image display apparatus of claim 28,
wherein the prism includes
a first transparent substrate that, on one hand, totally reflects the image light emergent from the display device inside the first transparent substrate so as to eventually direct the image light to the optical pupil, and, on the other hand, transmits the outside light to direct the outside light to the optical pupil, and
a second transparent substrate for cancelling refraction that the outside light suffers when transmitted through the first transparent substrate.

31. A head-mounted display comprising:
the image display apparatus of claim 28; and
a supporting member supporting the image display apparatus in front of a viewer's eye.

32. The head-mounted display of claim 31,
wherein the supporting member includes
a pair of temples, each making contact with a temporal region of the viewer,
a frame that pivotally supports the temples and supports the image display apparatus, and
nose pads that are brought into contact with a nose of the viewer.
